(19) United States
(12) Patent Application Publication
(10) Pub. No.: US 2012/0254042 A1
(43) Pub. Date: Oct. 4, 2012

(54) Integrated Mobile/Server Applications

(75) Inventor: Peter LUDEMANN, Los Altos, CA (US)

(73) Assignee: Google Inc., Mountain View, CA (US)

(21) Appl. No.: 13/435,729

(22) Filed: Mar. 30, 2012

Related U.S. Application Data
(60) Provisional application No. 61/470,249, filed on Mar. 31, 2011.

(51) Int. Cl. G06Q 20/40; G06Q 20/14; G06F 15/16

(52) U.S. Cl. 705/78; 709/203; 705/34

(57) ABSTRACT

Methods and systems for providing integrated mobile/server applications are provided. An application may be received at a server from a third party. A request for information may be received at the server from a user's device and a token that identifies a user on the user's device, wherein the request and the token were transmitted by the user's device. It may be determined, by the server, that the user is authorized to make a request of the application. A response to the request using the application may be generated using the application. Accounting may be performed by the server so that the user can be billed according to a billing preference of the third party.

### CROSS REFERENCE TO RELATED APPLICATIONS

This application claims the benefit of U.S. Provisional Appl. No. 61/470,249, filed Mar. 31, 2011, which is incorporated by reference herein in its entirety.

### BACKGROUND

1. Field

Embodiments described herein relate generally to mobile and server applications.

2. Background

With the growth of mobile computing has come a boom in mobile application development. The mobile applications have grown in both complexity and capability. While many mobile applications are standalone and operate solely on a user's mobile device, other mobile applications are more integrated and require communication with a server. The server may provide some information and/or functionality to the integrated mobile application. While there exist many services by which an application developer may easily launch and provide a standalone mobile application (an application that does not need to communicate with a server), the conventional systems for providing or deploying an integrated mobile application are more complex and place a greater burden upon the application developer. These conventional systems require an application developer or supplier to expend significant resources beyond developing and improving the integrated mobile application.

### SUMMARY

Methods and systems for providing an integrated mobile server application are disclosed herein.

According to an example embodiment, a method is disclosed. In this method, an application can be received by a server from a third party. A request for information and a token that identifies a user on the user's device may be received by the server from a user's device, the request and the token being transmitted by the user's device. It may be determined, by the server, that the user is authorized to make a request of the application. A response to the request may be generated using the application. Accounting can be performed by the server so that the user can be billed according to a billing preference of the third party

According to another example embodiment, a server is disclosed. The server may include an authorization engine that may determine whether a user is authorized to make requests for information of an application installed on the server responsive to a received request generated by a device of the user. The request may have been transmitted by the user's device. An application engine may execute the application to generate a response to the request responsive to a determination that the user is authorized to make requests of the application. An accounting engine may bill the user according to a preference of the third party.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a conventional system for enabling a user to interact with a third party server.

FIG. 2 illustrates a system for providing an integrated mobile server application according to an example embodiment.

FIG. 3 illustrates a system for providing an integrated mobile server application with load balancing according to an example embodiment.

FIG. 4 illustrates a method for servicing an integrated mobile application according to an embodiment.

FIG. 5 illustrates a method for initializing an integrated mobile application on a server according to an embodiment.

FIG. 6 illustrates an example computer system in which embodiments of a system for providing an integrated mobile server application, or portions thereof, may be implemented as computer-readable code.

### DETAILED DESCRIPTION

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

Disclosed herein is a system for providing an integrated mobile server application. The system herein may provide a mobile application developer or supplier a simple way by which the developer may deploy and/or otherwise provide the integrated mobile application to its clients or customers.

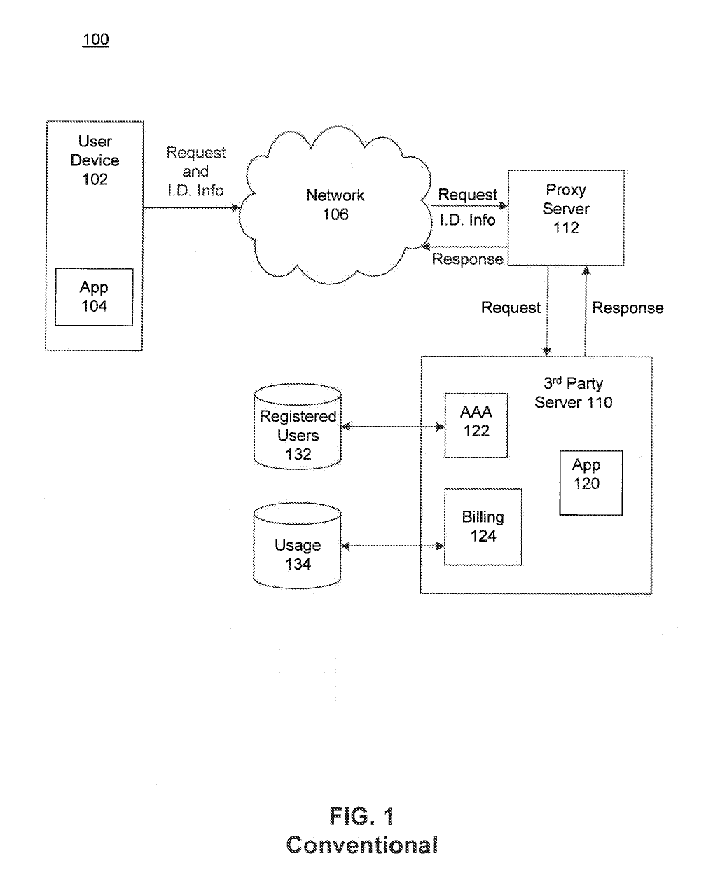

Conventional systems for mobile application include at least four different roles: an application developer, a host, an “application store”, and a user. The developer develops client-side and host-side applications. The user typically has a mobile device (e.g., a phone) that runs the client-side application. The host has a server that runs the server-side application. The application developer typically uploads the client-side application to the “application store” and the server-side application to the host. In addition to hosting the server-side application, the host can provide authorization/authentication/accounting (AAA), billing, load-balancing, and/or dynamic allocation of resources. In another implementation, a proxy server can be used to provide AAA, billing, and/or load-balancing services. In still another implementation, the client-side application can provide AAA, billing, and/or load-balancing services. The user interacts with the “application store” (also termed a “marketplace”), or other Internet-based service, to download the application, often for a fee. FIG. 1 illustrates a conventional mobile application system 100. In the system 100, a client-side application 104, operating on a user device 102, accesses an application that is being provided on a third party server 110 over a network 106. In an embodiment, the client-side application 104 can be, for example, implemented in a browser that communicates with the third party server 110 through a proxy server 112. In addition to facilitating communications over network 106, proxy server 112 can also provide load-balancing functionality.

To provide the client-side application 104 that communicates with a server using the conventional system 100, an application developer would have to not only develop the application, but also provide and maintain the third party server 110 that communicates with the application (which may be running inside the client-side application 104). In another embodiment, the application developer would also be required to provide the proxy server 112, which serves to facilitate communication between the third party server 110 and the user device 102.

The third party server 110 includes a server-side application 120, an authorization/authentication/accounting (AAA) engine 122, and a billing engine 124. The server-side application 120 is developed by the third party and is used to generate response to the requests received from the user device 102.

In the conventional system 100, when a request is generated from user device 102 for the client-side application 104, the request along with identification information is provided via the network to the proxy server 112. The user may have to provide identification information, such as a username and/or password, with the request or as part of an authentication and authorization procedure for each request or group of requests. The AAA engine 122 then performs an authentication and authorization using the database of registered users 132. If the user is authorized, the server-side application 120 processes the request and sends a response back to the proxy server 112. The third party server 110 can generate the response based on information included in the database 132. In another embodiment, third party server 110 can access another database (not shown in FIG. 1) that stores information regarding registered users. The response is then provided by the proxy server 112 back to the user device 102 over the network 106. The billing engine 124 logs usage of the client-side application 104 and bills the user for the use the client-side application 104. The billing engine 124 of the conventional system 100 often implements a one-time billing scheme, where a user of the user device 102 pays a one-time charge to download or use the client-side application 104. In another example, the client-side application 104 can be “ad-sponsored.” That is, the user can use the client-side application 104 but will be presented with advertisements during its use. In this example, the client-side application 104 can communicate with a separate “ads engine” that sends the advertisements to the user device 103.

The conventional system 100 requires an application developer to not only develop the client-side application 104 (that is operated by a user of the user device 102) and the server side server-side application 120, but also expend additional resources providing and maintaining the third party server 110 and/or proxy server 112 functionalities. The third party server 110 functionalities may additionally include anything from delivering content to scaling the system and performing load balancing, which could result in significant development and/or operational costs to the application developer. Additionally, the billing engine 124 often provides only a limited number of schemes by which the developer can charge a user to download or use the product (e.g., a one-time downloading charge). Alternatively, another entity can provide the third party server 110. Even in this alternative, however, the application developer must operate and maintain an AAA engine 122 and billing engine 124, as well as keep databases 132 and 134 current and secure.

Thus, in the conventional system 100, the application developer must also take on the role of the host for the application. Because many application developers do not have the resources to implement advanced most systems, the range of their possible business models can often be limited. For example, as noted above, application developers, in having to provide all of the functions of the third party server 110, may not have the resources to implement a nuanced billing system, and thus may only have a limited range of billing options (e.g., pay once on download). Moreover, maintaining and updating the third party server 110 can impose a substantial cost on the application developer, limiting the developer's ability to enter the market. Those skilled in the art will appreciate that other configurations for conventional systems exist. For example, in addition to providing the functions described above, the third party server 110 can also provide an application store function by allowing the user of the user device 102 download the client-side application 104 from the third party server 110 instead of from another party.

In embodiments described herein, systems that allow for a third party application developer to use an existing infrastructure enable interactive applications to be deployed with substantially reduced cost to the third party developer. For example, systems described herein can provide authentication, authorization, and accounting functionality, thereby allowing the application developer to focus its resources on developing and improving the application. These systems can be flexible, so that an application developer can provide its own server that generates responses to requests, or have the system generate responses automatically based on an uploaded program.

Moreover, the embodiments also benefit the user by limiting the number of parties that have his/her personal information and providing more options for the user to choose from. As described in further detail below, users often trust their personal information with service providers more than with individual third party developers. In particular, service providers often have greater technical expertise and more advanced facilities for safeguarding information. By having the service provider address certain information-sensitive functions (e.g., authorization), users may be more willing to use an application in the first place. In addition, having the service provider perform these functions also can be beneficial for the third party developer as it will not have to provide facilities needed to protect information, which often can be costly.

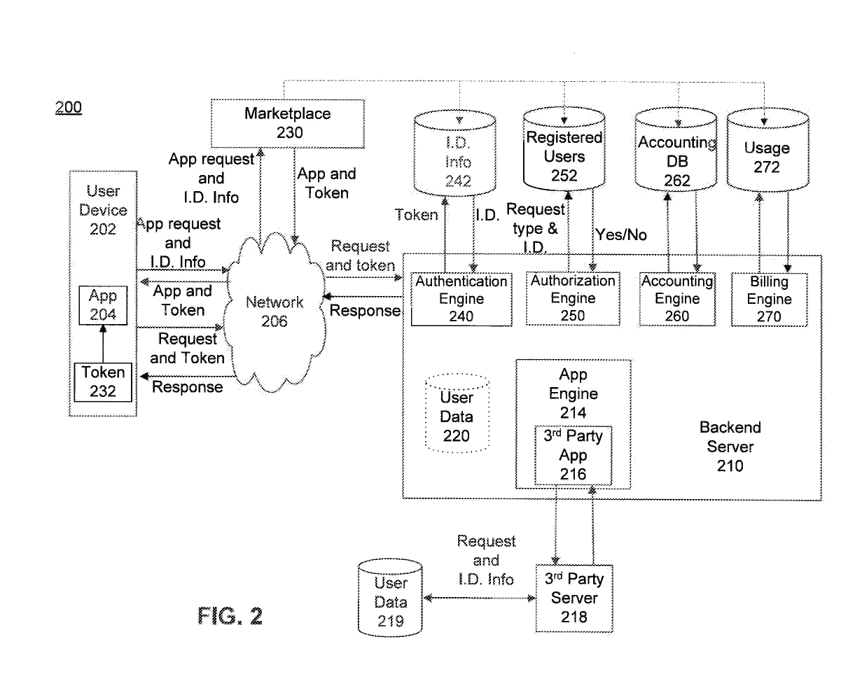

FIG. 2 illustrates a system 200 for providing an integrated mobile server application according to an example embodiment. An integrated mobile server application, hereinafter referred to as simply “mobile application,” can include any mobile application that communicates with one or more servers or other system(s) in order to operate or execute any of its functions. For example, a server may provide information, updates and/or other functionality to the mobile application. Though the system 200 will be most often referred to as including a mobile application in a mobile computing environment, it would be understood that the system 200 may also be used with desktop machines, connected to the Internet or other network, in a non-mobile environment whereby the desktop or laptop computers may access and/or download applications via a web browser or using an API.

The system 200 can allow a mobile application developer to install, upload or otherwise provision the mobile application and associated server functions along with billing options to a user and whereby the system 200 may provide much of the functionality that may be necessary to launch, provide or otherwise deploy the mobile application. The system 200 may allow an application developer to focus resources on the development of applications and corresponding server side code, and rely on the system 200 to provision all functionality and resources necessary to deploy the application and corresponding server side functionality. Once an application developer or other application supplier creates the mobile application, the system 200 allows the developer to upload or otherwise install the client-side application 204 on a server, configure the server to communicate with an application installed on a user's device, and provide accounting options on how to bill for usage of the application. The system 200 can then handle all other functionality associated with deploying and maintaining the application or service. In another embodiment, the system 200 can allow the application developer to provide its own server to provide some or all of the functionality described above (e.g., the server can generate responses to requests).

The system 200 may, for example, provide a marketplace where an application or service, as developed, supplied or otherwise conceived by a third party developer and uploaded or provided to the system 200, may be purchased and downloaded by clients or consumers. The system 200 may also provide server functionality to support the download and/or operation and usage of the application by the consumers. The server functionality may be configured by the third party, whereby the system 200 may supply the hardware and other connectivity resources to implement the desired server functionality. Furthermore, the system 200 may perform the needed accounting to facilitate any billing or pricing scheme as desired or specified by the third party developer, including but not limited to, the one-time download charges often offered by conventional systems 100, and periodic or request-based schemes. The system 200 may also track users and/or usage of the application whose service is being provided by the system 200.

The system 200 may provide an application developer a simple way to launch and/or otherwise provide or deploy a mobile application to a user base. The system 200 may allow application developers to focus their energies on developing mobile applications without expending additional resources on maintaining servers and/or other resources for scaling, authentication, communication, authorization, billing, usage, delivery and/or other deployment functionality that may be required in allowing users to use the mobile applications they have created. Moreover, the system 200 can provide an efficient way to deploy multiple versions of the same mobile application. For example, the system 200 can provide an efficient way for the third party developer to initially test a Beta version of an application and then to deploy the final version of the application.

System 200 may launch and/or otherwise provide the mobile application functionality, including server processes as may be required to provide the functionality requested by users of the mobile application. The system 200 may do so in a manner that is unnoticed by users of the mobile applications provided by the system 200, in that a user would have no knowledge as to whether the system 200 is providing the functionality supporting the execution of the mobile application or whether that functionality is being provided directly by the mobile application developer.

As described above, the system 200 may offer an application developer a one-stop shop for all resources necessary to deploy any integrated mobile server application. In particular, the application developer can develop the client-side and server-side applications and have the remaining functions provided by the architecture of FIG. 2. However, a third party developer may choose Which functionality of the system 200 to use for any particular application deployment, and may rather provide some functionality separately through the third party's own or other resources outside of the system 200. It is understood that the system 200 is configurable to meet whatever requirements are desired by a third party application developer, including but not limited to providing proxy services to any systems the third party developer desires to use in conjunction with the system 200.

The system 200 includes a user device 202 on which an client-side application 204 is installed. The user device 202 may include any computing device, e.g., a mobile phone, a desktop, a laptop, a game console, or other processing device. Particularly, the user device 202 may include a mobile device, such as a smart-phone or tablet PC, with which a user may purchase and/or operate the client-side application 204. In an alternate embodiment, the user device 202 can access the client-side application 204 using a program installed on the users device 202, which in turn access the client-side application 204 through an application programming interface (API).

The client-side application 204 may include any application or service that may be configured to operate on or with the user device 202. The client-side application 204 may include an integrated mobile application that is configured to communicate with a backend server 210 over a network 206. The client-side application 204 may include an application and/or a webpage. Or, for example, the client-side application 204 may include an application built to operate on or as a wrapper to a mobile web browser and/or an HTML application. In an example embodiment, the client-side application 204 may be accessible to the user device 202 through a browser. Additionally or alternatively a user may download or otherwise access the client-side application 204 using the user device 202.

The network 206 may include any telecommunications or computer network(s) that communicatively couple the user device 202 to one or more units, such as the backend server 210. In an example embodiment, the network 206 may include any type of data network or combination of data networks including, but not limited to, a local area network (LAN), a medium area network, or a wide area network such as the Internet. The network 206, for example, may be a wired or wireless network that allows the user device 202 and the backend server 210 to communicate with each other. The network 206 may further support Internet protocols (e.g., world-wide-web HTTP) protocols and services. For example, the user device 202 may include a mobile phone or tablet PC that is wirelessly connected to the Internet, in which case the network 206 may be provided through a service provider.

The backend server 210 may include any computing device configured to communicate with one or more user devices 202. The backend server 210 may be configured to communicate with the user device 202 via the network 206 to provide functionality and/or other information associated with installing and/or using the client-side application 204. The backend server 210 may include or otherwise have accessible functional units, as discussed below, to support the deployment of the client-side application 204 to one or more user devices 202.

The backend server 210 includes an application engine 214. The application engine 214 may include any computing device or computing logic configured to support and/or communicate with the client-side application 204. The application engine 214 may be configured with a third party application 216. The third party application 216 may include whatever functionality and/or data that may be needed to support the usage of the client-side application 204, whereby the application engine 214 may operate, execute, or run the third party application 216 on the backend server 210. For example, if the user makes a request using the client-side application 204, then the request may be processed by the third party application 216, which may retrieve, gather, calculate, and/or otherwise perform whatever processing may be necessary to handle the request, and provide a response back to the client-side application 204. In an embodiment, the third party application 216 can be provided to the app engine 214 in the form of a program written in one of any number of different programming languages, e.g., Python or Java.

According to an example embodiment, a third party developer can provide a third party server 218. The third party server 218 may provide any functionality, information or support associated with deploying the client-side application 204. For example, the third party server 218 may perform any functionality that may be performed by the application engine 214 operating the third party application 216, or may perform additional functionality not already supported by the third party application 216, including but not limited to data gathering. In one example embodiment, the third party application 216 may act as a proxy that points to the third party server 218 that performs all response processing associated with requests from the client-side application 204. In another example embodiment, the third party application 216 may provide or push information that may be processed or stored by the third party server 218 in the user data 219. The third party developer can provide the 3^{rd} party server 218 and/or user data 219 in a variety of different ways. For example, the third party developer can provide its own hardware device(s) that serve as the third party server 218. Alternatively, a third party developer can provide the third party ser ver 218 and/or user data 219 through the use of cloud computing, e.g., through the use of the Amazon Elastic Computer Cloud (Amazon EC2) web service.

In an alternate embodiment, one or more functions of the authentication engine 240, the authorization engine 250, the accounting engine 260, or the billing engine 260 can be provided by the third party server 218 or an application uploaded by a developer to the app engine 214 or one or more suitable engines implemented in the third party server 218. For example, if a developer desires to use information only available to it in providing any of the above functions and further desires that the information not be made available to backend server 210, the developer can develop an application that implements that particular function. In such an embodiment, the developer may still rely on the backend server 210 to provide other functions, e.g., AAA or billing.

The user data 219 may include any data collected that is associated with users of the client-side application 204. For example, the user data 219 may include data such as one or more of how often users use the client-side application 204, the location where it is used, what time of day the usage occurs, the length of use, the features being used most/least often, problems experienced during use, or other errors, etc. The third party server 218 may access or otherwise process the data received from the third party application 216, including but not limited to storing the information in the database 219. The third party server 218 may optionally provide a response to third party application 216. In another embodiment, backend server 210 can include a user data database 220. User data database 220 can store some or all of the information that user database 219 stores, but can be accessible to the backend server 210, and particularly the app engine 214, without having to interact with the third party app 216. For example, the user data 220 can allow app engine 214 to generate user-specific responses in an embodiment in which the third party server 218 is not present, i.e., when all of the functionality to be provided to the user is included in the third party application 216.

According to an example embodiment, a third party may develop the client-side application 204, upload it to the system 200, configure the third party application 216 and set accounting options (that are discussed in more detail below), and the system 200 may deploy the client-side application 204. The system 200 may provide the client-side application 204 to a marketplace 230. The marketplace 230 may include any virtual marketplace or online store where the client-side application 204 may be downloaded by a user of the user device 202 (e.g., for a fee). For example, the user device 202 may include a mobile phone that connects to the marketplace 230 over the network 206, whereby the user may purchase applications, including the client-side application 204, that are configured to operate on the mobile phone. In alternate embodiments, the client-side application 204 can be installed on the user device 204 in a number of different ways. For example, and without limitation, the client-side application 204 can be downloaded from a website, transferred to the user device 202 using a port of the user device 202 (e.g., a USB port), or input to the user device 202 via a memory card.

As shown in the system 200, a user using the user device 202 may search the marketplace 230 for an application, e.g., using user device 202. Upon identifying the client-side application 204 in the marketplace 230, an application request and identification (ID) information may be sent from the user device 202 to the marketplace 230 and/or backend server 210. The backend server 210, as will be discussed in greater detail below, may bill an account associated with the user device 202 for the client-side application 204. Alternatively, marketplace 230 can directly bill the user for the purchase of client-side application 204. The marketplace 230 (which may, in some embodiments, be supported or provided, at least in part, by the backend server 210) may provide the client-side application 204 and a token 232 to the user device 202. Thus, the marketplace 230 can provide provisioning functionality for the third party developer, in that the marketplace 230 can determine which users are authorized to use the client-side application 204 and determine which type of requests, if any, the user device 202 is authorized to make of backend server 210. In an embodiment, once the marketplace 230 provides the application to the user device 202, the marketplace server 230 can update identification database 242, registered users database 252, accounting database 262, and/or usage database 272 so that the user can use the client-side application 204 and can, optionally, be billed for its use. In a further embodiment, the marketplace 230 can also perform more advanced functions. For example, the marketplace 230 can dynamically provision devices that make up the backend server 210 for the user. For example, the backend server 210 can be made up of a number of different computing devices. In response to a user purchasing the client-side application 204, the marketplace 230 can allocate one or more of these devices for operation with the client-side application 204. Thus, while the marketplace 230 is shown in FIG. 2 as being separate from backend server, its operation can be intertwined with the backend server 210. In an embodiment, the token can be generated by a separate authentication or authorization service.

The token 232 may include a virtual object that identifies and/or authorizes a user (and/or the user device 202) to use the client-side application 204 and/or one or more features therewith. The token 232 may include identification information associated therewith, such that the backend server 210 may use token 232 to identify the user or the user device 202. Moreover, based on the token 232, the backend server 210 may determine whether a user of the user device 202 is authorized to access one or more features of the client-side application 204. Alternatively, this can be done with the identification gleaned from the token 232. The client-side application 204 may then be installed on or otherwise made accessible to a user of the user device 202, and the token. 232 may be associated therewith such that when a request is made from the client-side application 204, the token 232 may be transmitted or otherwise associated with the request. In an embodiment, the token 232 is an encrypted element that identifies the user or the user device 202. For example, the token 232 can be generated based on a user ID associated with the user. In another example, the token 232 can be generated based on information associated with the user device 202. For example, the token 232 can include an encrypted form of a Media Access Control (MAC) address associated with the user device 202. In embodiments where the token 232 is encrypted, the backend server 210 can store a key needed to decrypt the token 232.

Those skilled in the art will appreciate that a number of different authentication schemes can be used in the system of FIG. 2. For example, the token 232 can also include information that identifies the particular client-side application 204. For example, the marketplace 230 can generate the token 232 when the client-side application 204 is downloaded onto the user device 202.

As described above, the user of the user device 202 may use the client-side application 204 that has been downloaded and/or purchased from the marketplace 230. It may be that certain features of the client-side application 204 may be used locally on the user device 202 and one or more other features may require some communication with an outside system (e.g., the backend server 210). For example, the client-side application 204 can be a weather service that runs locally on the user device 202, but also requires updates received from backend server 210. When the user of the user device 202 requests one of these features that requires information from an outside source, a request for information along with the token 232 may be transmitted to the backend server 210 over the network 206. In alternate embodiments, the client-side application 204 can use push or pull methods to obtain information from the backend server 210. This way, information can be stored or cached and presented to the user when, for example, the user device 202 is offline.

The backend server 210 may receive the request and token 232 from the user device 202 and process the request using one or more functional units as described. An authentication engine 240 may authenticate the request, an authorization engine 250 may determine whether the request is authorized (in other embodiments, the authorization engine 250 may determine the type of request if necessary), and an accounting engine 260 may perform accounting and/or billing based on the usage (e.g., request and type of request) of the feature(s) of the client-side application 204 requested or any other type of billing known to those skilled in the art. Additionally or alternatively, accounting engine 260 can return a yes/no response that indicates whether the user has enough available funds to make the request. In response to a “no” response from the accounting engine 260, the backend server 210 can return a response requiring additional funds or can provide degraded service to the user (e.g., increasing the response time for a request).

The authentication engine 240 authenticates the request. For example, the authentication engine 240 may authenticate the request based on the token 232. The authentication engine 240 may, for example, compare the token 232 against a database or other storage of identification information 242. Based on the comparison, the authentication engine 240 may determine an identity of the user and/or the user device 202 as associated with the request. The authentication engine 240 may be able to authenticate the request without a user of the user device 202 entering any additional login, identification, and/or password information, thus performing automatic authentication based on the request.

The authorization engine 250 may determine whether the request is authorized by the user and/or user device 202 (as identified by the identification received from the id information database 242). The authorization engine 250 may compare the identification and type of the received request against information stored in a registered users database 252. The registered users database 252 may include information indicating which identifications (of users and/or user devices 202) are registered to submit requests to/from the client-side application 204 and/or which request types are authorized to be performed by those users. The authorization engine 250 may compare the identification and request against the registered users information database 252 to determine (yes or no) whether the user is authorized to perform the request. Some users may be authorized to only make certain requests. In such a way, the functionality that the user may make use of may be limited if the third party so chooses or if the user has requested that certain functionality be disabled. For example, different pricing schemes may allow certain users to access different levels of functionality. Additionally, the authorization engine 250 can also qualify or disqualify a user for a particular level of requests. For example, the registered users database 252 can additionally include a field specifying what types of requests the particular user is authorized to make. For example, this functionality may allow some users to Obtain higher levels of service (e.g., multimedia applications v. plain text) based on a particular payment plan.

An accounting engine 260 may perform accounting and/or billing functions associated with the client-side application 204. The accounting engine 260 may store accounting options associated with deploying the client-side application 204 in an accounting database 262. The third party (e.g., application developer) may configure the accounting engine 260 to reflect whatever pricing model is consistent with the third party's business model. For example, the third party may elect a one-time charge to download the client-side application 204, a subscription service, a charge for using particular features of the client-side application 204, a trial period, tiered pricing and/or any other combination of pricing models the third party desires. The accounting engine 260 can be configured to perform the accounting needed to facilitate the third party's chosen billing scheme. For example, for a pay-as-you-go billing scheme, the accounting engine 260 can be configured to record the number of requests. Additionally or alternatively, if the third party stipulates that the cost of using the client-side application 204 and making requests of backend server 210 varies based on the time or date of the request, the accounting engine 260 can also record that information along with the request. In an alternate embodiment, accounting and billing functions can be split between two different engines. Thus, backend server 210 may additionally include a billing engine 270 that handles the above-mentioned billing functions. As shown in FIG. 2, the billing engine can communicate with a usage database 272 that can be used to store the user's activities with respect to the client-side application 204.

FIG. 2 shows separate databases 242, 252, 262, and 272 coupled to backend server 210 for purposes of illustration only. As would be appreciated by those skilled in the art, backend server 210 can access information needed to perform authentication, authorization, and accounting functions in other ways. For example, this information can be stored using cloud systems accessed by backend server 210.

The accounting engine 260 may store and/or otherwise log whatever charges are associated with a user's (e.g., user device 202) access of the client-side application 204 in the accounting database 262. The accounting database 262 may include a log or other accounting of charges associated with one or more users (and/or user devices 202) using the client-side application 204. According to an example embodiment, the charges as determined by the accounting engine 260 may be billed to a user or account associated with the user device 202 on a monthly bill or statement. For example, if the user device 202 is a mobile phone, then the charges may be accrued on or otherwise billed to a user's mobile phone bill in conjunction with the user device's network carrier. In other example embodiments, the accounting engine 260 may bill or charge a user account associated with the user device 202 after the request has been satisfied.

Though only shown in the context of a single client-side application 204 and single application engine 214, the backend server 210 (which itself may include a server farm or other grouping of computational devices) may operate to provide efficiency to multiple different applications 204 operating on multiple user devices 202 and accessing one or more application engines 214 running on one or more backend servers 210.

After the request has been authenticated and determined authorized (and accounted and/or billed for, if necessary), the request may be provided to the application engine 214 as configured with the third party application 216. The application engine 214 may then process the request, corresponding with the third party server 218 (if necessary). The third party server 218 may store identification and/or request information in the user data database 219 and provide a response to the third party application 216. The third party application 216 may then transmit or otherwise provide a response back to the client-side application 204, via the network 206. In an embodiment, user data database 219 may be included in or as part of backend server 210.

The system 200 as shown includes a backend server 210 and multiple engines 214, 240, 250, 260, and 230 running in association with the backend server 210. However, it is understood that the system 200 may operate on one or many servers or other machines capable of providing similar functionality as described herein. It is understood that the system 200 provides a third party developer (or other provider of the client-side application 204) a system 200 through which the developer only needs to provide the client-side application 204, server functionality (e.g., third party application 216) and accounting preferences (for the accounting engine 260), and the system 200 may provide any and all functionality as desired by the developer associated with deployment of the client-side application 204.

It may be that the developer prefers to operate or own one or more of the functionalities described herein on the developer's own third party server 218, in which case, the system 200 may provide all other remaining functionality associated with deployment for the client-side application 204. Additionally or alternatively, the application developer can use one or more plug-ins to later customize or augment functionality to the client-side application 204. Furthermore, the application developer or the host can use plug-ins to customize or augment the functionality of one or more of engines 240-270. The developer may pick and choose whatever functionality as described herein and provided by the system 200 as the developer desires in order to deploy the client-side application 204. The system 200 may be customizable based on the client-side application 204 being deployed and the preferences of the third party application provider.

The embodiment of FIG. 2 has been described with respect to the example in which the developer provides the information to be used in the identification database 242. In another embodiment, however, the identification database 242 can be provided by the backend server 210. For example, the user may prefer to give his/her identification information to a single party (i.e., the host of backend server 210) rather than giving this information to the developer of each application on his/her user device 202. Thus, identification of the user can be done without interaction with the developer.

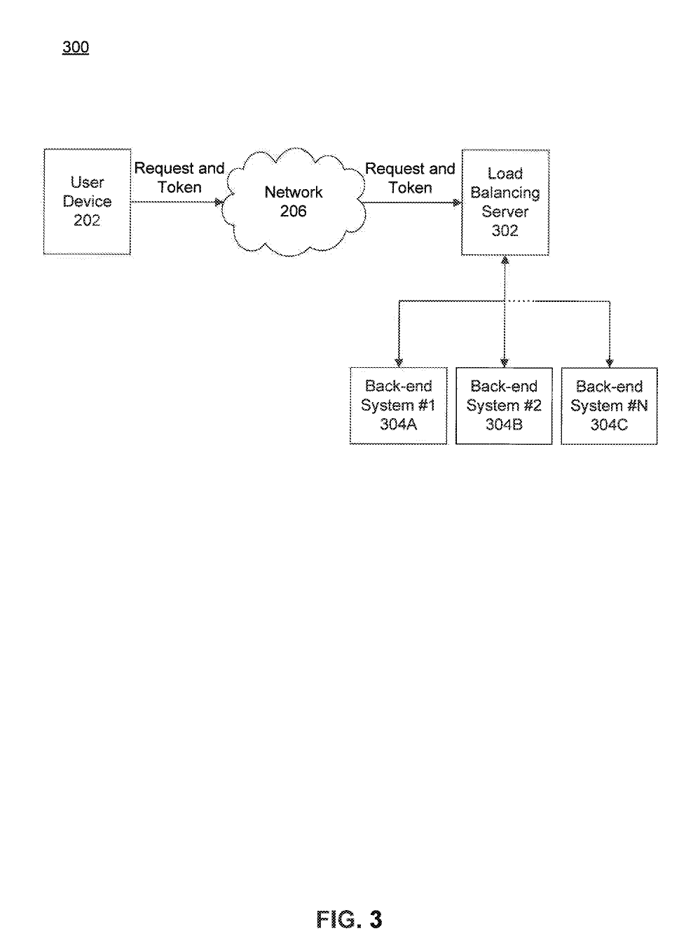

FIG. 3 illustrates a system 300 for providing an integrated mobile server application with load balancing, according to an example embodiment. In the system 300, a request and a token may be received by a load balancing server 302 from the user device 202 over the network 206. The load balancing server 302 may then provide the request and/or token to one or more backend systems 304A, 304B, 304C.

The load balancing server 302 may include any computing device or application that manages multiples systems as if one larger system. For example, if multiple users are requesting functionality from one or more applications 204, the load balancing server 302 may distribute those requests amongst the back-end systems 304A-C according to algorithms known to those skilled in the art. The back-end systems 304A-C may include any systems that perform any portion of the functionality described with respect to the system 200 above. In an example embodiment, the back-end systems 304A and 304B may perform identical functionality. In another example embodiment, a backend system 304C may include a proxy to one or more third party servers 218 and/or other systems and/or may include one or more backend servers 210 and/or engines associated therewith.

Load balancing server 302 can also conduct health checks for backend systems 304A-C. By sending messages to each of backend systems 304A-C and measuring the response time of each backend system, load balancing server 302 can estimate a load of each of backend systems 304A-C and whether any of backend systems 304A-C is overloaded.

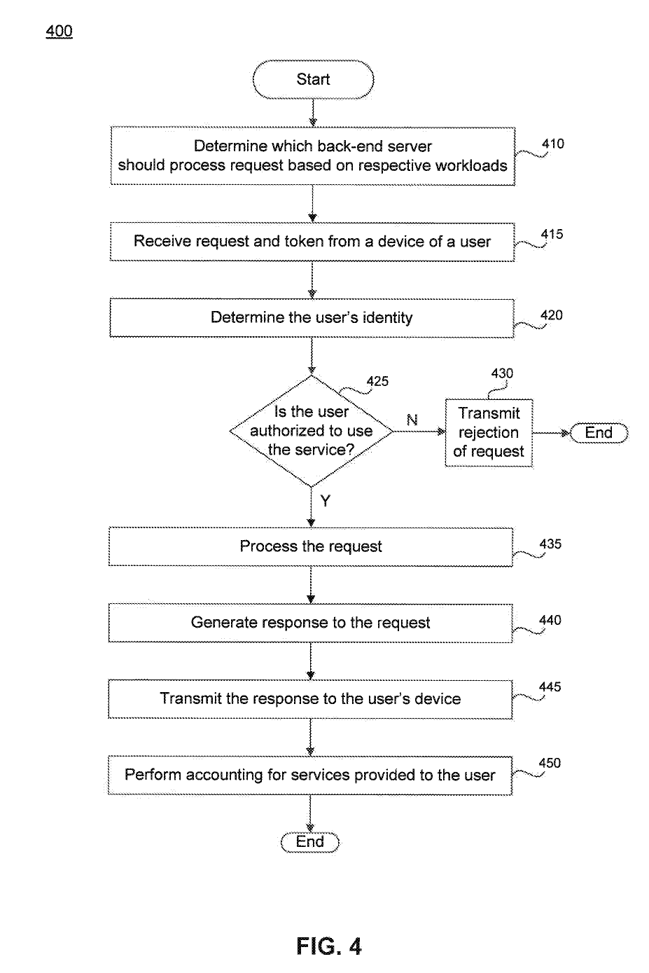

FIG. 4 illustrates a method 400 for servicing an integrated mobile server application, according to an embodiment. At step 410, after a start step, it is determined which back-end server should process a request based on respective workloads. For example, the load balancing server 302 may determine the respective workloads and/or capabilities of the back-end systems 304A-C to determine which of the back-end system(s) 304A-C is to handle a received request or process. The load balancing server 302 may direct one or more processes to one or more backend servers 210, including the engines associated therewith. As would be appreciated by those skilled in the art, step 410 can be executed at a number of different stages in the operation, e.g., first (as shown in FIG. 4) or after step 415.

At step 415, a request and a token is received from the user's device. For example, as described above, the backend server 210 may receive a request and the token 232 from the user device 202. The token 232 may have been received from the marketplace 230 when the client-side application 204 was purchased and/or otherwise downloaded or accessed, as described above. Also, as described above, the token 232 can be generated based on a number of different values associated with the user or the user device 202, e.g., the MAC address associated with the user device 202.

At step 420, the user's identity (or the user device's identity) is determined. For example, the authentication engine 240 may determine the identity of the user or the user's device from the token 232 by comparing it against the identification information 242. The token 232 may include identification information identifying the user and/or user device 202. For example, as described above, when downloading the client-side application 204, a user of the device 202 may have had to submit identification information, which may have then been associated with the token 232 received from the marketplace 230 or other authorization service. Also, as described above, marketplace 230 can provide the token and corresponding identification to the identification information 242 after the client-side application 204 is downloaded onto the user device 202.

At step 425, it may be determined whether the user is authorized to use the application. For example, the authorization engine 250 may determine whether the user and/or user device 202 is authorized to make the request or use the service by comparing the identification and request type against the registered user's information stored in database 252, to which the authorization engine may receive a yes or a no response. In other example embodiments, the user may be automatically authorized based on the type of request being made, and/or the authorization engine 250 may authorize the user. In still other example embodiments, authorization as performed by the authorization engine 250 may depend, at least in part, on the accounting engine 260, e.g., Whether the user has enough funds in an account to support the request or whether the user has exceeded a predetermined number of requests for a given period. In an embodiment, the registered users database 252 can include an identification of a plan associated with each user. In such an embodiment, the type of the request is compared to the plan associated with the user to determine whether the request is authorized.

At step 430, if the user is not authorized to use the service, a rejection of the request is transmitted. For example, if the authorization engine 250 determines that the user (e.g., user device 202) is not authorized to request or access the service or information requested, the authorization engine 250 may transmit a rejection of the request as the response back to the user device 202 over the network 206 and the process may end. In another example embodiment, if the user is not already authorized to request the service, then the authorization engine 250 may inform the user of this and/or authorize the user or request information from the user to authorize access and continue to step 435. In an embodiment, the backend server 210 can provide a standard message that is sent to the user device 202 in the event that the user is not authorized to make the request of the backend server 210. In another embodiment, the backend server 210 can allow the third party developer to provide customized messages. For example, these messages can be based on the reason the request was not authorized. For example, if the user's plan does not support a particular type of request, the message can recommend that the user upgrade his plan to one that supports the particular request.

At step 435, if the user is authorized to use the service, the request is processed. For example, if the authorization engine 250 determines or otherwise receives a response that the user is authorized to make the request, then the request may be provided to the third party application 216 operating on the application engine 214.

At step 440, a response to the request is generated. For example, the third party application 216, running on the app engine 214, can generate a response to the request. For example, the third party application 216 can interact with the user data 220 to generate a response to the request. In another example embodiment, the backend server 210 can serve as a proxy that sends the request to the third party server 218. In such an embodiment, the app engine 214 can store a proxy configuration that automatically sends the request to the third party server 218. Upon receiving the request, the third party server 218 can generate a response to the request using, for example, information stored in the user data 219. In other embodiments, a response to the request can be generated as a result of interactions between the third party application 216 running on the app engine 214 and the third party server 218.

At step 445, the response is transmitted to the user device. For example, the application engine 214 may transmit the response back to the user device 202 via the network 206. The response may include data, a service, a code, another application, access to another system or any other response that may be determined application appropriate based on the response.

At step 450, accounting is performed according to an accounting preference of the third party. In an embodiment, the accounting preference of the third party is a function of the third party's billing preference. For example, the accounting engine 260 may record information needed to facilitate a billing scheme that the third party prefers. The third party's billing and/or accounting preferences as may be stored in the accounting database 262. The accounting engine 260 may, in an example embodiment, record the transactions and/or requests by a user or user device 202, and compute the bill based on the logged activity. In an embodiment, the user can be billed at times determined by the third party developer. For example, the user can be billed according to a pay-as-you-go plan at predetermined times during a month (e.g., the 1^{st} and 15^{th} of every month) in which case accounting engine may record ever request made by user device 202. In other example embodiments, the third patty may prefer to bill the user after the number of requests in a given time period by the user device 202 exceeds a predetermined threshold number of requests. In such an embodiment, accounting engine may record only those requests that occur after the threshold has been met. In another embodiment, accounting can be done by processing logs resulting from other steps. For example, by reviewing logs of the types of responses generated in step 440, it can be determined what services were offered to the user. This information can be used in determining how to bill the user for his use of the client-side application 204. In still another embodiment, accounting can be done through the process of “deep packet inspection” by which individual packets of information generated by the backend server 210 can be inspected to determine the user's activities. The backend server 210 can bill the user based on the determined activity.

In an embodiment, billing can be done by billing a particular form of payment that the user has made available (e.g., a credit card). In another embodiment, however, the marketplace 230 and/or the backend server 210 can be able to communicate with the provider of the user's data communication plan (e.g., the user's wireless carrier). In such an embodiment, the bill can be included in the bill provided to the user by the provider.

After step 450, the process ends. It would be understood by one of skill in the art that though the steps of the process 400 are presented in a sequential order, the steps may be performed in any order and potentially repeated in order to reach the same ends.

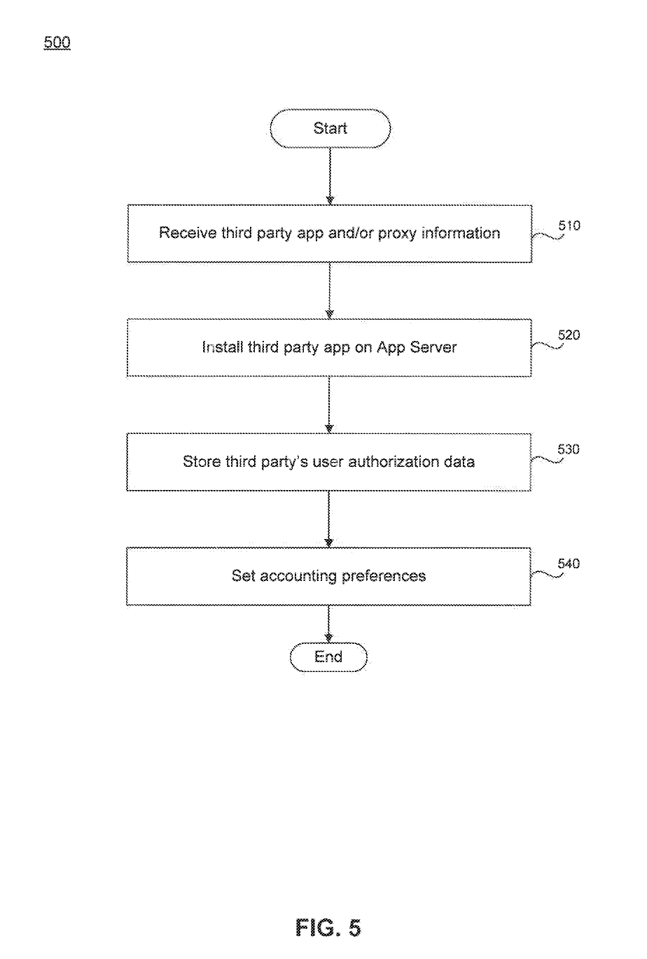

FIG. 5 illustrates a method 500 for initializing an integrated mobile application on a server according to an embodiment. At step 510, after a start step, a third party application and/or proxy information is received. For example, the client-side application 204 and the corresponding third party application 216 may be received by the system 200. For example, a third party developer may create, design, or otherwise provide the client-side application 204 and corresponding third party application 216. The client-side application 204 may, for example, be received by the system 200 and provided to the marketplace 230, and the third party application 216 can be uploaded to the app engine 214. Additionally or alternatively, the app engine 214 can receive proxy information instructing the app engine 214 to transmit the request to the third party server 218.

At step 520, a third party application may be installed on an application server. For example, the third party application 216 that corresponds to providing functionality and/or information to the client-side application 204 may be installed on the application engine 214 of the backend server 210. In other example embodiments, portions of the third party application 216 and/or copies of it may be installed across multiple servers 210 as managed by a load balancing server 302.

At step 530, third party's user authorization data is stored. For example, the third party may have user data 219 that needs to be accessed as part of the functionality associated with the client-side application 204, in which case the third party application 216 may include a link, pointer or connection (via a third party server 218) to the user data 219, which may be hosted or stored by the third party. In other example embodiments, the user data 219 may be installed directly with the backend server 210 in the form of the user data 220. In an embodiment, the information needed to perform the authentication and authorization operations can be provided by the marketplace 230 after the client-side application 204 is downloaded onto the user device 202.

At step 540, accounting preferences are set. For example, the third party may provide accounting preferences to the accounting engine 260. The accounting preferences may include anything related to accounting, billing and/or pricing as associated with the client-side application 204. Example accounting preferences, which may be stored in the accounting database 262, may include but are not limited to pricing information on when and how much to bill different users, billing frequency, usage limitations, and free and premium models of pricing.

After step 540, the process ends. It would be understood by one skilled in the art that though the steps of the process 500 are presented in a sequential order, the steps may be performed in any order and potentially repeated in order to reach the same ends. After the process 500 ends, the client-side application 204 may be available and ready for deployment via the system 200.

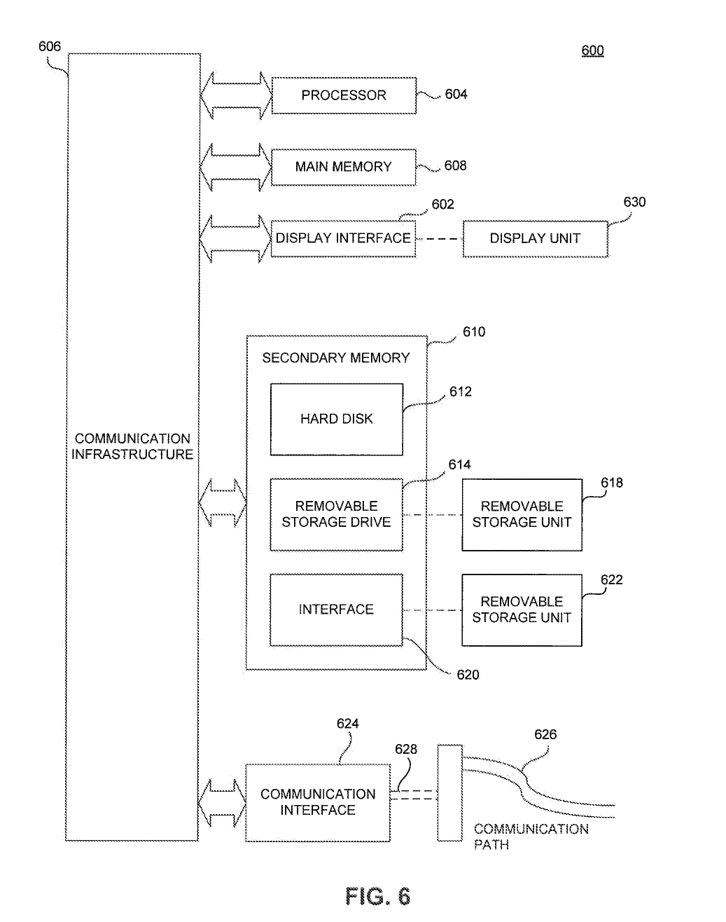

FIG. 6 illustrates an example computer system 600 in which embodiments of a system for providing an integrated mobile server application, or portions thereof, may be implemented as computer-readable code. For example, user device 202, marketplace 230, backend server 210 and/or engines (216, 240, 250, 260) may be implemented in computer system 600 using hardware, software, firmware, tangible computer readable storage media having instructions stored thereon, or a combination thereof and may be implemented in one or more computer systems or other processing systems. Hardware, software, or any combination of such may embody any of the modules, procedures and components in FIGS. 2-5.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 606, for example, a bus, message queue, network, or multi-core message-passing scheme.

Computer system 600 also includes a main memory 608, for example, random access memory (RAM), and may also include a secondary memory 610. Secondary memory 610 may include, for example, a hard disk drive 612, removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well-known manner. Removable storage unit 618 may comprise a floppy disk, magnetic tape, optical disk, etc. which is read by and written to by removable storage drive 614. As will be appreciated by persons skilled in the relevant art, removable storage unit 618 includes a computer usable storage medium having stored therein computer software and/or data.

Computer system 600 (optionally) includes a display interface 602 (which can include input and output devices such as keyboards, mice, etc.) that forwards graphics, text, and other data from communication infrastructure 606 (or from a frame buffer not shown) for display on display unit 430.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Computer program medium and computer usable medium may also refer to memories, such as main memory 608 and secondary memory 610, which may be memory semiconductors (e.g. DRAMs, etc.).

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the method illustrated by the flowcharts in FIGS. 4 and 5. Accordingly, such computer programs represent controllers of the computer system 600. Where the invention is implemented using software, the software may be stored in a computer program product and loaded into computer system 600 using removable storage drive 614, interface 620, and hard disk drive 612, or communications interface 624.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnotogical storage device, etc.).

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method, comprising:
receiving, by a server, an application from a third party;
receiving, by the server, a request for information from a user's device and a token that identifies a user on the user's device, wherein the request and the token were transmitted by the user's device;
determining, by the server, that the user is authorized to make a request of the application;
generating, by the server, a response to the request using the application using the application; and
performing, by the server, accounting according to an accounting preference of the third party associated with the application.

2. The computer-implemented method of claim 1, farther comprising:
determining, by the server, an identity of the user based on the token.

3. The computer-implemented method of claim 1, wherein receiving comprises:
receiving, by the server, the request from a load balancing server, wherein the load balancing server is configured to choose to send the request to the server based on the load of the server.

4. The computer-implemented method of claim 1, wherein generating comprises:
interacting, by the server, with a server of the third party.

5. The computer-implemented method of claim 1, wherein the token is generated based on at least one account of the user with a second application installed on the server.

6. The computer-implemented method of claim 1, wherein the request was generated by a second application, wherein the second application was installed on the user's device by a marketplace server and wherein the token was generated by the marketplace server.

7. The computer-implemented method of claim 1, further comprising:
installing the application on an application server.

8. The computer-implemented method of claim 1, wherein the determining comprises:
determining that the user is authorized to make requests of the application based on authorization information of the third party.

9. The computer-implemented method of claim 8, further comprising:
storing the authorization information in a locally-accessible database.

10. The computer-implemented method of claim 1, wherein the request was generated by an application installed on the user's device, wherein the application installed on the user's device is an HTML application.

11. A server, comprising:
an authorization engine configured to determine whether a user is authorized to make requests for information of an application installed on the server responsive to a received request generated by a device of the user, wherein the request was transmitted by the user's device;
an application engine configured to execute the application to generate a response to the request responsive to a determination that the user is authorized to make requests of the application; and
an accounting engine configured to bill the user according to a preference of the third party.

12. The server of claim 11, further comprising:
an authentication engine configured to determine an identity of the user based on a token received along with the request.

13. The server of claim 11, wherein the application engine is configured to interact with a server of the third party to generate the response to the request.

14. The server of claim 11, wherein the server is configured such that the third party can install the application on the application engine.

15. The server of claim 11, wherein the server is configured to receive the request from a load balancing server and wherein the load balancing server is configured to choose to send the request to one of many servers based on the load on the server.

16. The server of claim 11, wherein the request was generated by a second application, wherein the second application is installed on the user's device.

17. The server of claim 11, wherein the accounting engine is configured to interact with the third party to set the preference.

18. The server of claim 11, wherein the application engine is coupled to a database configured to store a list of registered users authorized to make requests of the application, and can store additional per-user information in the database.

19. The server of claim 18, wherein the authorization engine is configured to query the database with information identifying the user.

20. The server of claim 12, wherein the token is generated based on an account that the user has with a second application installed on the server.
